(19) United States
(12) Patent Application Publication
(10) Pub. No.: US 2013/0051061 A1
(43) Pub. Date: Feb. 28, 2013

(54) ILLUMINATION DEVICE

(71) Applicant: Cheol-Jun Yoo, Cheonan (KR)

(72) Inventor: Cheol-Jun Yoo, Cheonan (KR)

(21) Appl. No.: 13/593,936

(22) Filed: Aug. 24, 2012

(30) Foreign Application Priority Data
Aug. 25, 2011 (KR) 10-2011-0085301

(51) Int. Cl. F21V 8/00; F21V 17/16; F21V 17/12

(52) U.S. Cl. 362/559

(57) ABSTRACT

An illumination device includes: a light source including a substrate and a light emitting device mounted on the substrate; a light guide unit mounted on the substrate to cover the light emitting device and guiding light from the light emitting device to an upper side of the substrate to allow the light to be emitted from the upper side; and a main body unit having the light source fastened thereto and including an external connection unit connected to an external power source to supply power to the light source.

### CROSS-REFERENCE TO RELATED APPLICATIONS

This application claims the priority of Korean Patent Application No. 10-2011-0085301 filed on Aug. 25, 2011, in the Korean Intellectual Property Office, the disclosure of which is incorporated herein in its entirety by reference.

### BACKGROUND OF THE INVENTION

1. Field of the Invention

The present disclosure relates to an illumination device.

2. Description of the Related Art

A light emitting diode (LED) is a type of light emitting device capable of implementing light of various colors by changing compound semiconductor materials such as such as GaAs, AlGaAs, GaN, InGaP, or the like.

An LED, advantageously having an excellent monochromic peak wavelength and excellent optical efficiency, being compact and environmentally friendly, and consuming low levels of power, and the like, is commonly used for various applications such as TVs, computers, illumination devices, automobiles, and the like.

Recently, energy reduction initiatives have regulated the use of incandescent electric lamps, low-efficiency illumination devices, and the replacement of incandescent electric lamps with high-efficiency illumination devices, such as a light emitting device, has been actively undertaken by light emitting device manufacturers and general illumination device manufacturers.

However, with a light emitting device, it is difficult to provide illumination having a radiation form similar to that of the light distribution characteristics of incandescent electric lamps, in terms of luminescent properties and a heat dissipation structure. Thus, recently launched light emitting device lamps do not have a large light distribution angle due to the structural characteristics of the light emitting device in which light is only emitted from one side, and, though maintaining the shape of existing incandescent lamps, illumination having a desired radiation form may not be realized.

In particular, an illumination area of a light emitting device lamp is small and the reverse side of a lamp cover, which is not illuminated, may be dark. Thus, research into implementing a spherical light source having a radiation form such as that of an incandescent electric bulb is ongoing.

### SUMMARY OF THE INVENTION

An aspect of the present disclosure provides an illumination device having a simpler structure, using a light emitting device as a light source, and having a lateral and rear side thereof illuminated in a radiation form in addition to a front side, thus having improved light distribution characteristics.

According to one embodiment, there is provided an illumination device including: a light source including a substrate and a light emitting device mounted on the substrate; a light guide unit mounted on the substrate to cover the light emitting device and guiding light from the light emitting device to an upper side of the substrate to allow the light to be emitted from the upper side; and a main body unit having the light source fastened thereto and including an external connection unit connected to an external power source to supply power to the light source.

The light guide unit may include a guide part having one end mounted on the substrate and guiding light from the light emitting device formed to a predetermined height above the substrate and a lens part provided on the other end of the guide part and emitting guided light radially from the upper side of the substrate.

The guide part may include an accommodation recess formed in one end face mounted on the substrate and accommodating the light emitting device therein.

The light guide unit may further include a refractive layer formed on an outer surface of the guide part.

The guide part may be made of a plastic or glass material, and the refractive layer may be made of a material having a refractive index lower than that of the guide part.

The light guide unit may further include a reflective layer formed on an outer surface of the refractive layer.

The reflective layer may be made of a metallic material or a resin material containing a light reflective material.

The lens part may have any one of a circular shape, an oval shape, and a polyhedral shape.

The lens part may include protrusions formed on an outer surface thereof.

A space between the accommodation recess and the light emitting device may be filled with an adhesive or a phosphor layer.

The substrate may further include a depressed recess formed in an upper surface thereof on which the light guide unit is mounted, and light from the light emitting device mounted in the recess may be reflected to the light guide unit.

The substrate may further include a mounting recess in which the light guide unit is mounted.

The illumination device may further include a fastening unit allowing the light guide unit to be detachably mounted on the substrate.

The fastening unit may include a female screw thread provided in the substrate and a male screw thread provided on the light guide unit to engage with the female screw thread, and fastening may be performed by fastening the female screw thread and the male screw thread.

The fastening unit may include an adapter provided at one end of the light guide unit coupled with the substrate, and the male screw thread may be formed on the adapter.

The fastening unit may include an adapter provided at one end of the light guide unit coupled with the substrate and an auxiliary adapter provided on the substrate such that it corresponds to the adapter, and the female screw thread may be formed on an inner face of the adapter and the male screw thread may be formed on an outer face of the auxiliary adapter provided on the substrate.

The fastening unit may include a plurality of coupling holes provided in the substrate and a plurality of elastic snap fits having stop protrusions and provided on the light guide unit, and fastening may be performed by stop-fixing the snap fits and the coupling recesses.

The fastening unit may include an adapter provided at one end of the light guide unit coupled with the substrate, and the snap fits may be formed on the adapter.

The illumination device may further include a cover unit covering the light source and the light guide unit to protect them.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic exploded perspective view of an illumination device according to an exemplary embodiment;

FIG. 2 is an exemplary schematic sectional view of the illumination device of FIG. 1, according to one embodiment;

FIGS. 3A and 3B are exemplary schematic sectional views showing a light source of the illumination device of FIG. 1, according to one embodiment;

FIGS. 4A and 4B are exemplary schematic views showing another example of the light source of FIG. 3A, according to one embodiment;

FIG. 5 is an exemplary schematic sectional view of a light guide unit in the illumination device of FIG. 1, according to one embodiment;

FIGS. 6A to 6C are schematic sectional views showing various examples of a receiving recess in the light guide unit of FIG. 5, according to certain exemplary embodiments;

FIGS. 7A and 7B are schematic sectional views showing states in which an adhesive or a phosphor layer is provided in the receiving recess of the light guide unit of FIG. 5, according to certain exemplary embodiments;

FIG. 8 is a schematic sectional view of a lens part of the light guide unit in FIG. 5, according to one exemplary embodiment;

FIGS. 9A to 9C are schematic sectional views showing various examples of a substrate of an illumination device according to another exemplary embodiment;

FIGS. 10A to 10C are schematic sectional views showing a light source and a light guide unit in the illumination device according to another exemplary embodiment;

FIG. 11 is a schematic view showing a fastening unit in the illumination device according to another exemplary embodiment;

FIGS. 12A and 12B are schematic views showing a modification of the fastening unit of FIG. 11, according to certain exemplary embodiments;

FIGS. 13A and 13B are schematic views showing another example of the fastening unit of FIG. 11, according to certain exemplary embodiments; and

FIGS. 14A and 14B are schematic views showing a modification of the fastening unit of FIGS. 13A and 13B, according to certain exemplary embodiments.

### DETAILED DESCRIPTION

Embodiments of the present disclosure will now be described in detail with reference to the accompanying drawings. The invention may, however, be embodied in many different forms and should not be construed as being limited to the embodiments set forth herein. In the drawings, the shapes and dimensions of elements may be exaggerated for clarity, and the same reference numerals will be used throughout to designate the same or like components.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. Unless indicated otherwise, these terms are only used to distinguish one element from another. For example, a first chip could be termed a second chip, and, similarly, a second chip could be termed a first chip without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Embodiments described herein will be described referring to plan views and/or cross-sectional views by way of ideal schematic views. Accordingly, the exemplary views may be modified depending on manufacturing technologies and/or tolerances. Therefore, the disclosed embodiments are not limited to those shown in the views, but include modifications in configuration formed on the basis of manufacturing processes. Therefore, regions exemplified in figures have schematic properties, and shapes of regions shown in figures exemplify specific shapes of regions of elements, and the specific properties and shapes do not limit aspects of the invention.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

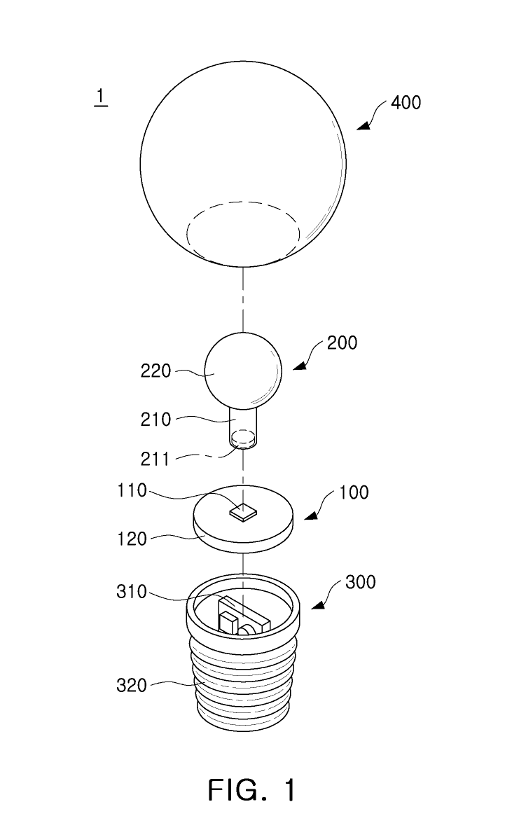

An illumination device according to an exemplary embodiment will be described with reference to FIGS. 1 through 8.

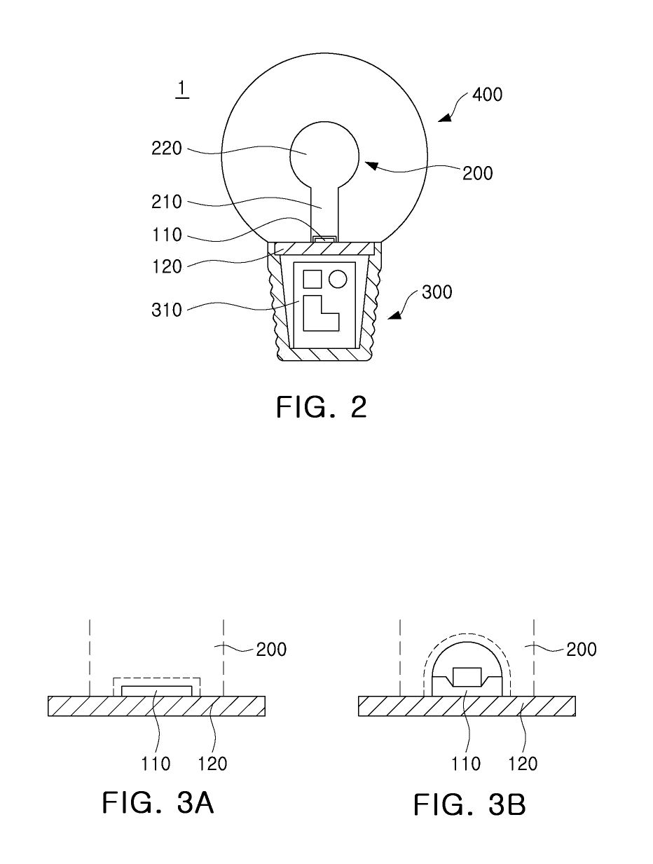

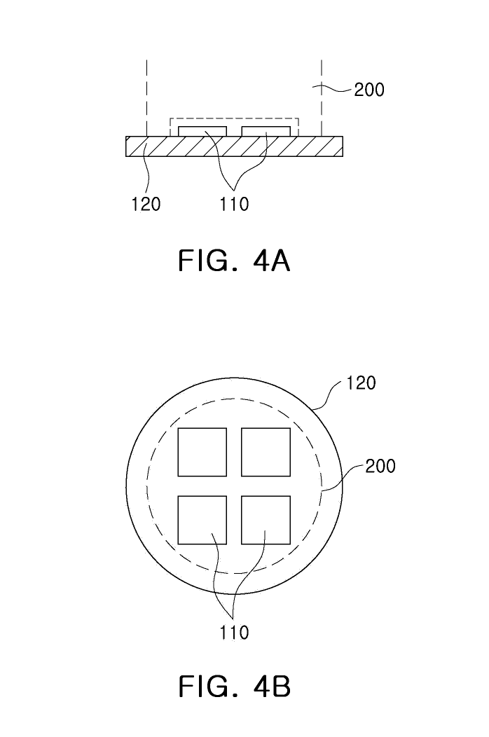

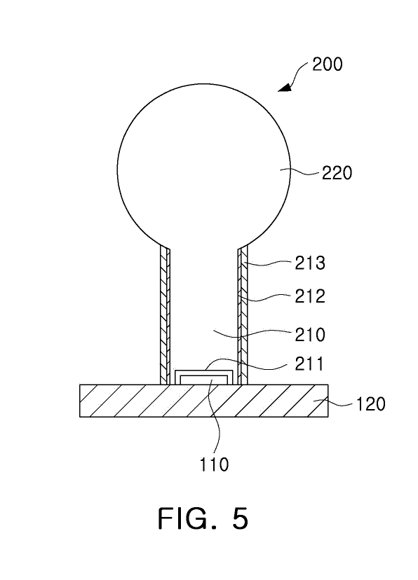

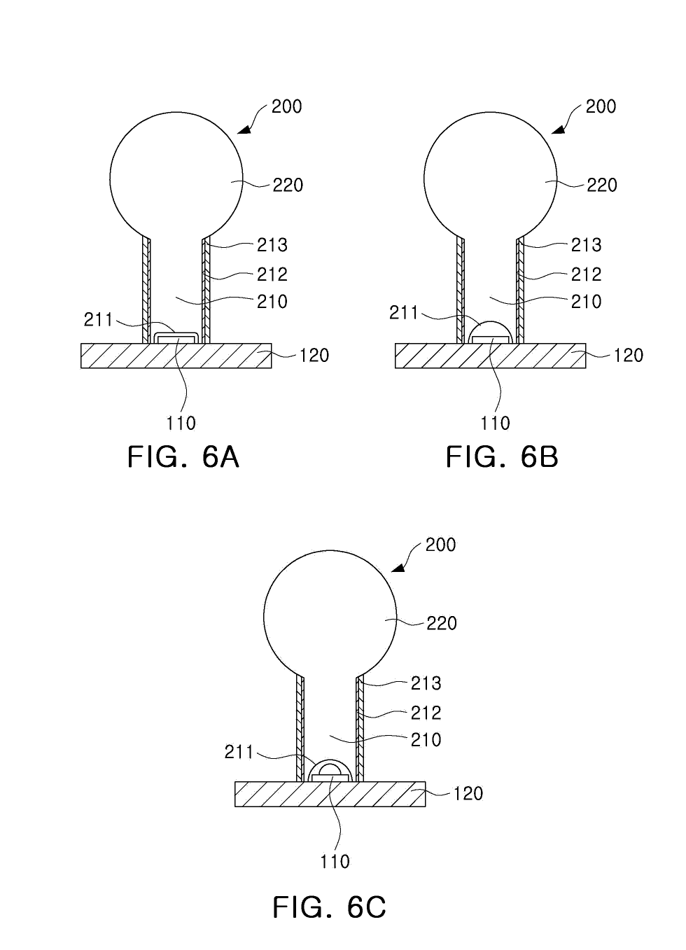

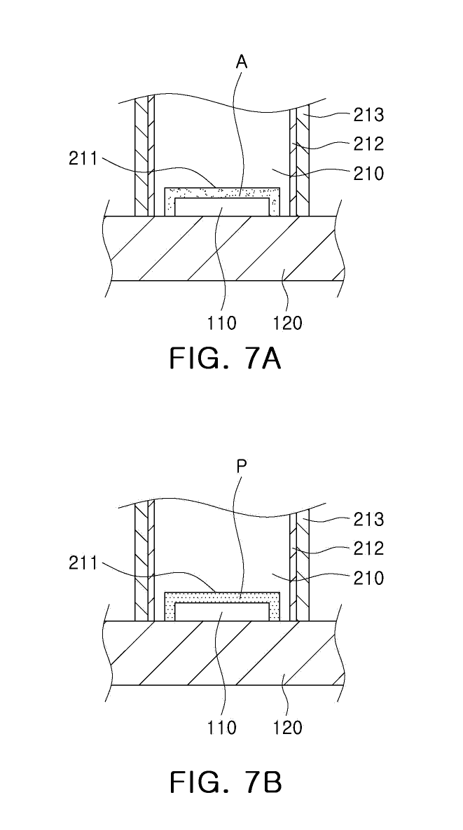

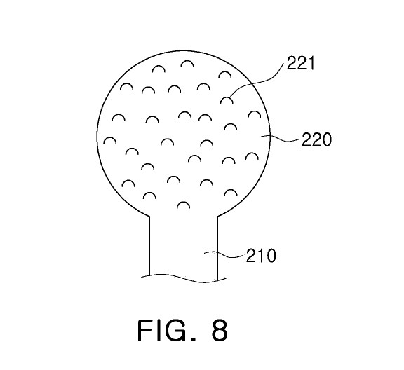

FIG. 1 is a schematic exploded perspective view of an illumination device according to an exemplary embodiment. FIG. 2 is an exemplary schematic sectional view of the illumination device of FIG. 1. FIGS. 3A and 3B are exemplary schematic sectional views showing a light source of the illumination device of FIG. 1. FIGS. 4A and 4B are exemplary schematic views showing another example of the light source of FIG. 3A. FIG. 5 is an exemplary schematic sectional view of a light guide unit in the illumination device of FIG. 1. FIGS. 6A to 6C are exemplary schematic sectional views showing various examples of a receiving recess in the light guide unit of FIG. 5. FIGS. 7A and 7B are exemplary schematic sectional views showing states in which an adhesive or a phosphor layer is provided in the receiving recess of the light guide unit of FIG. 5. FIG. 8 is an exemplary schematic sectional view of a lens part of the light guide unit in FIG. 5.

With reference to FIGS. 1 and 2, an illumination device 1 according to one embodiment may include a light source 100, a light guide unit 200, and a main body unit 300. The illumination device 1 according to one embodiment may further include a cover unit to cover and protect the light source 100 and the light guide unit 200.

The light source 100 includes a substrate 120 and a light emitting device 110 mounted on the substrate 120 and electrically connected to a circuit pattern.

The light emitting device 110, a semiconductor device outputting light having a certain wavelength according to an electrical signal applied from the exterior, may include a light emitting diode (LED). The light emitting device 110 may output blue light, red light, or green light, according to a material contained therein, or may output white light.

As shown in FIGS. 3A and 3B, the light emitting device 110 includes an LED chip, or a packet in which an LED chip is mounted. Also, as shown in FIGS. 4A and 4B, the light emitting device 110 may include a plurality of LED chips or a multi-chip package (MCP) in which a plurality of LED chips are mounted. In this case, the light emitting devices 110 may be arranged in a matrix form, and the light emitting devices 110 may be homogeneous light emitting devices outputting light beams, each having the same wavelength, or heterogeneous light emitting devices, emitting light beams each having a different wavelength.

The substrate 120, a type of printed circuit board (PCB), may be made of, for example, an organic resin material containing epoxy, triazine, silicon, polyimide, and the like, or any other organic resin materials. Also, the substrate 120 may be made of a ceramic material such as AlN, Al₂O₃, or the like, or a metal and a metal compound. Specifically, the substrate 120 may be a metal-core printed circuit board (MCPCB), a type of metal PCB, in terms of heat dissipation.

The substrate 120 with the light emitting device 110 mounted thereon may include a circuit wiring (not shown) electrically connected with the light emitting device 110, and may further include an insulating layer (not shown) having withstand voltage characteristics.

The light guide unit 200 is mounted on the substrate 120 to cover the light emitting device 110 and guides light from the light emitting device 110 to an upper side of the substrate 120 so as to be emitted from the upper side of the substrate 120.

In detail, as shown In FIG. 5, the light guide unit 200 includes a guide part 210 guiding light from the light emitting device 110, and a lens part 220 emitting light guided along the guide part 210. The guide part 210 and the lens part 220 may be integrally formed.

The guide part 210, having one end fixedly mounted on the substrate 120, guides light from the light emitting device 110 up to a certain height from the substrate 120. The guide part 210 may be made of, for example, transparent acryl, PMMA, plastic, or a glass material. Thus, the guide part 210 guides light incident from the light emitting device 110 to the interior thereof through one end to the other end thereof in a total reflection manner.

The guide part 210 may have a cylindrical shape as illustrated in the drawings, but the present disclosure is not limited thereto and the guide part 210 may have various other shapes such as a square pillar or a polygonal pillar shape.

The guide part 210 includes an accommodation recess 211 formed in one end face mounted on the substrate 120 to accommodate the light emitting device 110 therein. The accommodation recess 211 may have a shape corresponding to the light emitting device 110. Thus, when the one end face of the guide part 210 is mounted on the substrate 120, the light emitting device 110 may be stably accommodated within the accommodation recess 211.

Also, the accommodation recess 211 may have a size appropriate for the light emitting device 110. Accordingly, when the guide part 210 is mounted on the substrate 210, the light emitting device 110 can be inserted into the accommodation recess 211 without a gap therebetween.

FIGS. 6A, 6B, and 6C show various types of accommodation recesses 211. The accommodation recess 211 may have a structure in which corner portions are gently rounded to have curvatures. The accommodation recess 211 may have a shape of a convex lens entirely having a curvature. In particular, when the light emitting device 110 is mounted as a package having a lens structure, the accommodation recess 211 may serve as a secondary lens, having an effect of increasing an extraction efficiency of light emitted from the light emitting device 110.

As shown in FIG. 7A, a space between the accommodation recess 211 and the light emitting device 110 is filled with a heat-resistant and light-transmissive adhesive A to fix the guide part 210. The adhesive A may be made, for example, of a high heat-resistant epoxy resin or a silicon resin, and in one embodiment, may be made of a material having the substantially same refractive index as that of the guide part 210.

Also, as shown in FIG. 7B, the space between the accommodation recess 211 and the light emitting device 110 may be filled with a phosphor layer P. The phosphor layer P converts the wavelength of light output from the light emitting device 110 into a wavelength of a desired color. For example, the phosphor layer P converts monochromatic light such as red light or blue light into white light. To this end, a resin used for forming the phosphor layer P may contain one or more types of phosphor material. Also, the phosphor layer P may contain an ultraviolet (UV) ray absorbent for absorbing UV rays generated by the light emitting device 110.

The phosphor layer P may be selectively made of a resin having high transparency allowing light generated from the light emitting device 110 to be transmitted therethrough with minimal loss. For example, the phosphor layer P may be made of an elastic resin. The elastic resin may be, for example, a gel type resin, such as silicon, or the like, on which light having a short wavelength may not have a lot of influence to cause problems such as yellowing, and has high refractive index to have excellent optical properties.

A refractive layer 212 is formed on an outer surface of the guide part 210 to cover the guide part 210. The refractive layer 212 may be formed on the outer surface of the guide part 210 through deposition or coating or may be attached as a thin film to the guide part 210.

The refractive layer 212 may be made of substantially the same material as that of the guide part 210. In this case, the refractive layer 212 may have a refractive index lower than that of the guide part 210. Preferably, the refractive layer 212 may be made of a material having a lower refractive index than that of the guide part 210. Namely, through the structure in which the refractive layer 212 is positioned outside of the guide part 210, the refractive layer 212 may have a lower refractive index, and light may be totally reflected and guided within the guide part 210, rather than being emitted to the outside from the guide part 210.

A refractive layer 213 may be formed on an outer surface of the refractive layer 212 to cover the refractive layer 212. The reflective layer 213 may block light such that it cannot be emitted from the guide part 210 to the outside, and reflects light moving toward the guide part 210 to prevent external light from being made incident to the guide part 210.

The reflective layer 213 may be made of a metallic material having high light reflectivity such as aluminum (Al). The reflective layer 213 may be formed to cover an outer surface of the refractive layer 212 or may be attached in the form of a thin film. Also, the reflective layer 213 may be made of a resin material including a light reflective material such as TiO₂.

The lens part 220 is provided on the other end of the guide part 210 whose one end is mounted on the substrate 120, to emit light guide along the guide part 210 radially at an upper side of the substrate 120.

As illustrated, the lens part 220 may have a circular shape, specifically, a spherical shape. Accordingly, the lens part 220 may implement a light distribution angle of a spherical light source such as an incandescent electric lamp. However, the shape of the lens part 220 is not limited thereto; the lens part 220 may have an oval shape or a polyhedral shape, or the like.

In one embodiment, the lens part 220 may be made of the same material as that of the guide part 210. The lens part 220 may have a diameter greater than that of a section of the guide part 210.

As illustrated in FIG. 8, protrusions 221 may be formed on an outer surface of the lens part 220. The protrusions 221 may cover the lens part 220 along the outer circumferential surface of the lens part 220. Accordingly, a light distribution angle of the lens part 220 can be enhanced such that light emitted from the lens part 220 is irradiated in a wider range.

The main body unit 300 serves as a housing member supporting the light source 100, and dissipates heat generated from the light source 100 to the outside. The main body unit 300 may be made, for example, of a metallic material having high heat conductivity or a plastic material such as a heat dissipation resin.

In one embodiment, the light source 100 is fixedly fastened to an upper portion of the main body unit 300. A power supply unit (e.g., a switched-mode power supply (SMPS)) 310 is provided in the main body unit 300 to supply power to the light source 100. An external connection unit 320 is provided at a lower portion of the main body unit 300 and connected to an external power source.

The cover unit 400 is mounted at an upper portion of the main body unit 300 to cover and protect the light source 100 and the light guide unit 200.

The cover unit 400 may be made of a material such as polycarbonate (PC), plastic, silica, acryl, glass, or the like. Preferably, the cover unit 400 is formed to be transparent to have light transmittance properties, but the present invention is not limited thereto.

In this manner, in the case of the illumination device 1 according to one embodiment, a planar light source is converted into a spherical light source through the light guide unit having the guide part 210 guiding light to the center of the lamp and the spherical lens part 220 disposed at the center of the lamp to irradiate light radially from the center of the lamp, whereby such a light distribution angle as that of the related art incandescent electric lamp can be implemented.

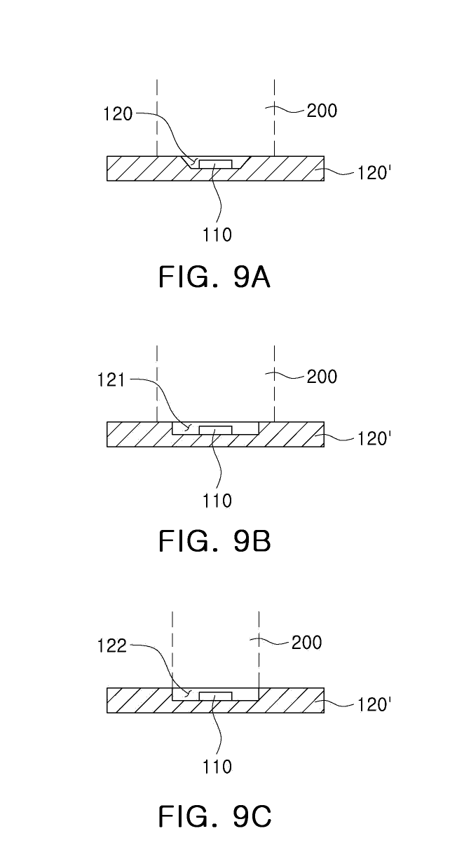

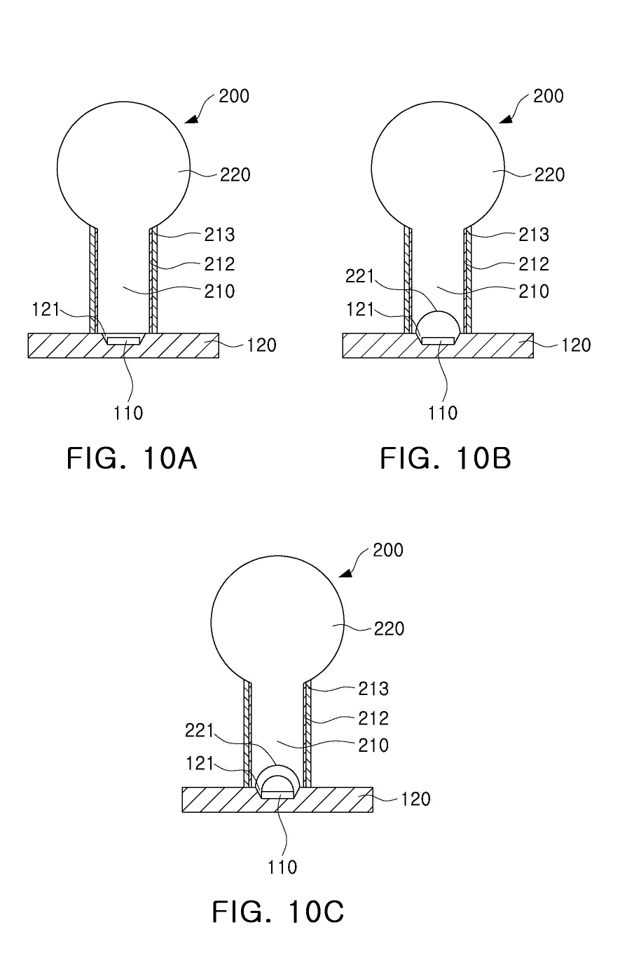

An illumination device according to another exemplary embodiment will be described with reference to FIGS. 9 and 10.

A basic structure of the illumination device according to the exemplary embodiment illustrated in FIGS. 9 and 10 is substantially the same as that of the embodiment illustrated in FIGS. 1 through 8, except for the structure of the substrate constituting a light source. Thus, hereinafter, the same repeated description as that of the foregoing embodiment will be omitted, and the configuration of the substrate will be largely described.

FIGS. 9A to 9C are schematic sectional views showing various examples of a substrate of an illumination device according to another exemplary embodiment, and FIGS. 10A to 10C are schematic sectional views showing a light source and a light guide unit in the illumination device according to another exemplary embodiment.

As illustrated in FIGS. 9 and 10, a substrate 120′ includes a recess 121 formed to be depressed downwardly in an upper surface on which the light guide unit 200 is mounted. The light emitting device 110 is mounted within the recess 121, and the recess 121 reflects light from the light emitting device 110 mounted therein to the light guide unit 200.

As shown in FIG. 9A, the recess 121 may be formed such that inner lateral sides thereof are sloped toward the light at a certain tilt. In this case, light emitted from the light emitting device 110 may be reflected from the sloped inner lateral sides and fully made incident to the light guide unit 200. The inner lateral sides of the recess 121 may be formed to have various tilts, and as shown in FIG. 9B, the inner lateral sides of the recess 121 may be vertical correspondingly to the light emitting device 110.

As shown in FIG. 9C, the substrate 121′ may have a mounting recess 122 in which the light guide unit 200 is mounted. The mounting recess 122 may be formed to have a size corresponding to that of the guide part 210 of the light guide unit 200 to allow the guide part 210 to fit therein. The mounting recess 122 may be formed to be slightly larger than that of the guide part 210, and in this case, the guide part 210 and the mounting recess 122 may be bonded through an adhesive (not shown).

As shown in FIG. 10A, when the recess 121 is formed on the substrate 120′, the accommodation recess 211 may not be formed on the guide part 210 of the light guide unit 200. Also, as shown in FIG. 10B, the accommodation recess 211 may be formed on the guide part 210. As shown in FIG. 10C, when the accommodation recess 211 is formed on the guide part 210, the light emitting device 110 may be mounted as a package in the recess 121.

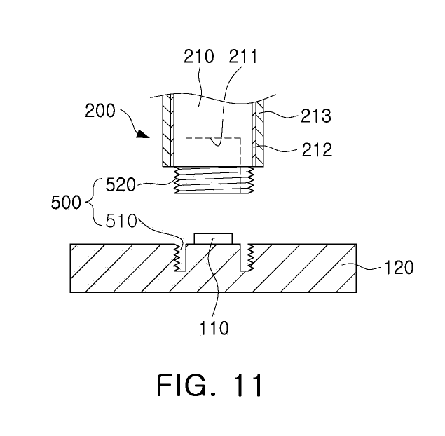

An illumination device according to other exemplary embodiments will be described with reference to FIGS. 11 through 14.

A basic structure of the illumination device according to the embodiments illustrated in FIGS. 11 through 14 is substantially the same as that of the embodiments illustrated in FIGS. 1 through 8, except for the structure in which the light guide unit is detachably mounted on the substrate. Thus, hereinafter, repeated description the same as those of the foregoing embodiments will be omitted, and the configuration of the structure for fastening the light guide unit and the substrate will largely be described.

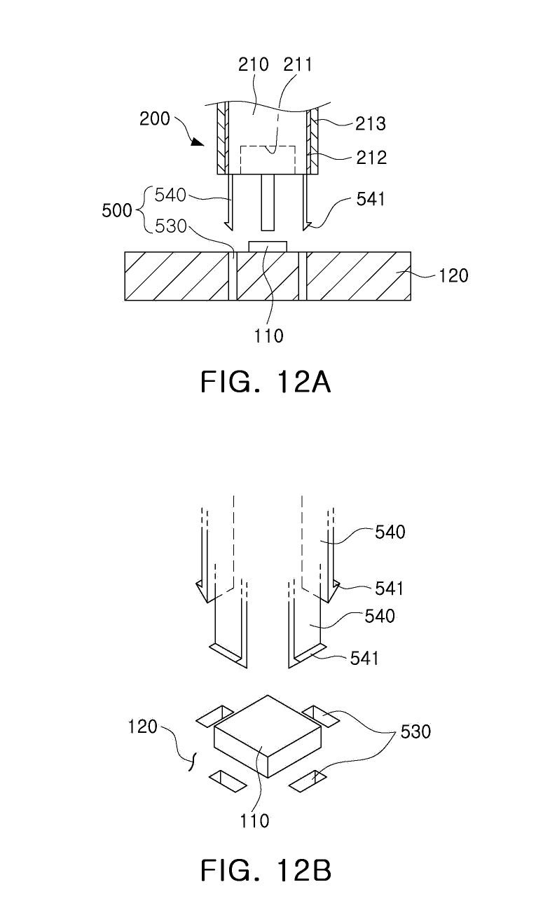

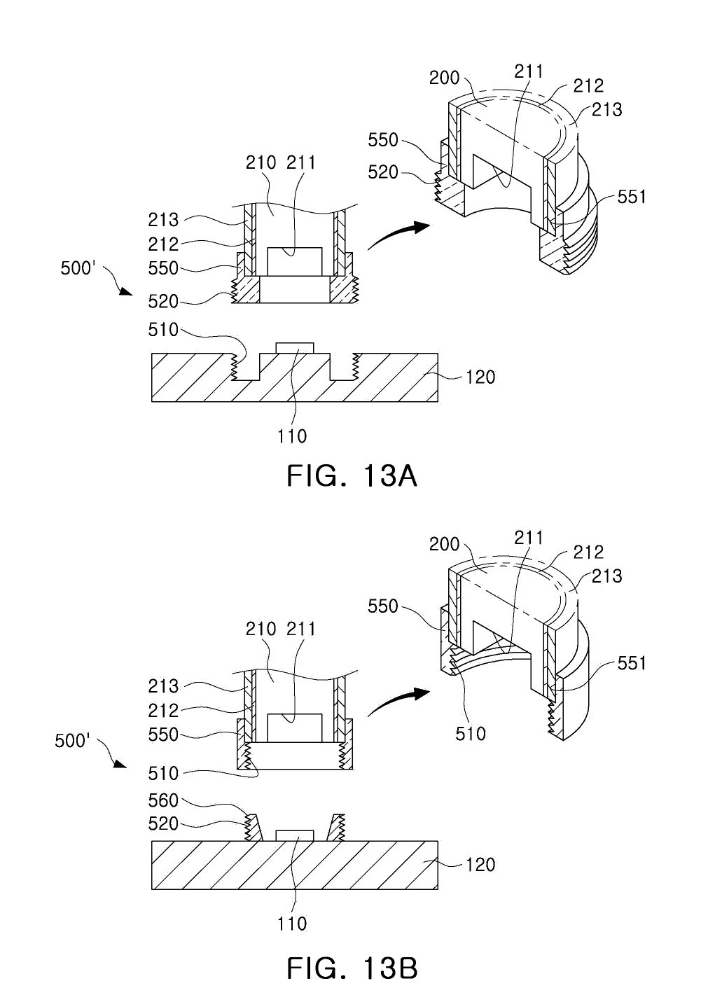

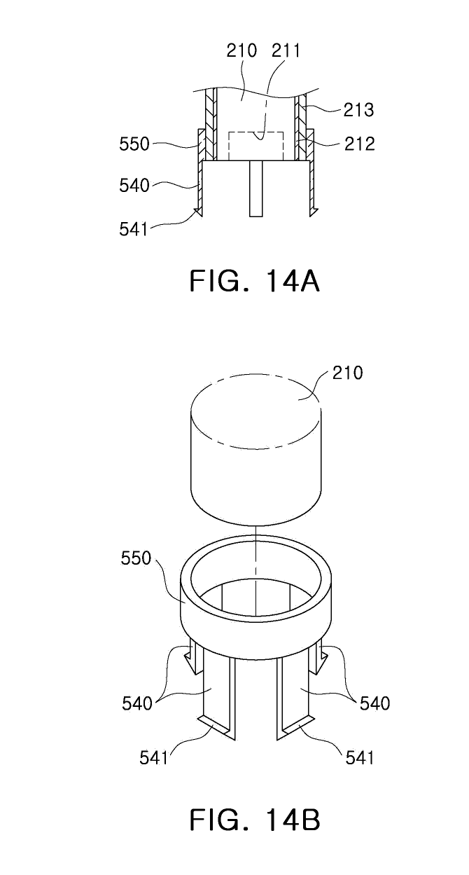

FIG. 11 is a schematic view showing a fastening unit in the illumination device according to another exemplary embodiment. FIGS. 12A and 12B are schematic views showing a modification of the fastening unit of FIG. 11. FIGS. 13A and 13B are schematic views showing another example of the fastening unit of FIG. 11. FIGS. 14A and 14B are schematic views showing a modification of the fastening unit of FIGS. 13A and 13B.

As illustrated, the light guide unit 200 and the substrate 120 include a fastening unit 500 allowing the light guide unit 200 to be detachably mounted on the substrate 120.

The fastening unit 500 may include a female screw thread 510 provided in the substrate 120 and a male screw thread 520 provided on the light guide unit 200 and engaged with the female screw thread 510. In detail, the male screw thread 520 is formed on an outer face of a lower end portion of the guide part 210 of the light guide unit 200, and the female screw thread 510 in mesh with the male screw thread 520 is formed to be depressed with a certain depth on an upper surface of the substrate 120. Accordingly, by fastening the female screw thread 510 and the male screw thread 520, the light guide unit 200 and the substrate 120 may be fastened to be detachably attached.

The light emitting device 110 is mounted to be surrounded by the female screw thread 510 on the upper surface of the substrate 120 with the female screw thread 510 formed thereon. In one embodiment, the accommodation recess 211 provided on the guide part 210 may be formed at an inner portion deeper from the lower end face of the guide part 210 in consideration of the depth of the female screw thread 510.

As shown in FIGS. 12A and 12B, the fastening unit 500 may include a plurality of coupling recesses 530 formed on the substrate 120 and a plurality of elastic snap fits 540 having a stop protrusion 541 and formed on the light guide unit 200 such that they correspond to the coupling recesses 530. In detail, the plurality of snap fits 540 are formed to extend from the lower end face of the guide part 210 of the light guide unit 200, and each of the end portions of the snap fits 540 has the stop protrusion 541. The plurality of coupling holes 530 are formed in positions corresponding to the positions of the snap fits 540 to allow the snap fits 540 to be inserted thereinto. Accordingly, the light guide unit 200 and the substrate 120 can be mutually detachably fastened as the snap fits 540 inserted in the coupling holes 530 are fixedly caught therein.

FIGS. 13A and 13B are schematic views showing another example of the fastening unit of FIG. 11.

As shown in FIGS. 13A and 13B, a fastening unit 500′ is different from the fastening unit 500 illustrated in FIGS. 11 and 12, in that the fastening unit 500′ is provided as a separate component coupled to the light guide unit 200. Namely, in the case of the fastening unit 500 illustrated in FIGS. 11 and 12, the fastening unit 500 is integrally formed with the light guide unit 200, while the fastening unit 500′ illustrated in FIGS. 13 and 14 is configured as a separate component and coupled with the light guide unit 200.

As shown in FIG. 13A, the fastening unit 500′ includes an adapter 550 provided at one end of the light guide unit 200 coupled with the substrate 120. The adapter 550 has an annular shape overall. The guide part 210 of the light guide unit 200 is insertedly coupled to an opening 551 provided at an upper end portion of the adapter 550, and the accommodation recess 211 provided at the lower end face of the guide part 210 is exposed through an opening provided at a lower end portion of the adapter 550.

As shown in FIG. 13A, the adapter 550 includes male screw thread 520 formed on an outer face of the lower end portion thereof. The male screw thread 520 meshes with the female screw thread 510 provided on the substrate 120.

Also, as shown In FIG. 13B, the adapter 550 may have a female screw thread 510 formed at an inner face of the lower end portion thereof, and in this case, an auxiliary adapter 560 with the male screw thread 520 formed on an outer face thereof may be formed on an upper surface of the substrate 120. The light emitting device 110 may be disposed at an inner center of the auxiliary adapter 560, and inner sides of the auxiliary adapter 560 may be formed to be sloped toward the light emitting device 110 with a certain tilt.

As shown in FIGS. 14A and 14B, the adapter 550 may include a plurality of snap fits 540 formed to extend from the lower end face thereof. The snap fits may be inserted into the coupling holes 530 formed on the substrate 120 and fastened in a stop (catch) fixing manner.

In this manner, since the light guide unit 200 may be easily separated from or coupled to the substrate 120, the light guide unit 200, as well as the light emitting device 110, can be easily replaced. Namely, when the light emitting device 110 or the light guide unit 200 has a problem, the corresponding part can be easily changed. Thus, the maintenance of the device can be facilitated.

As set forth above, according to various exemplary embodiments, although a light emitting device itself is used as a light source, even a lateral area and a rear area, in addition to a front area, can be simultaneously illuminated through radiated light, thus remarkably improving light distribution characteristics.

While the present disclosure has been shown and described in connection with the embodiments, it will be apparent to those skilled in the art that modifications and variations can be made without departing from the spirit and scope of the invention as defined by the appended claims.

What is claimed is:

1. An illumination device comprising:
a light source including a substrate and a light emitting device mounted on the substrate;
a light guide unit mounted on the substrate to cover the light emitting device and guiding light from the light emitting device to an upper side of the substrate to allow the light to be emitted from the upper side; and
a main body unit having the light source fastened thereto and including an external connection unit connected to an external power source to supply power to the light source,
wherein the light guide unit comprises a guide part having one end mounted on the substrate and guiding light from the light emitting device to a predetermined height above the substrate and a lens part provided on the other end of the guide part and emitting guided light radially from the upper side of the substrate.

2. The illumination device of claim 1, wherein the guide part comprises an accommodation recess formed in one end face mounted on the substrate and accommodating the light emitting device therein.

3. The illumination device of claim 1, wherein the light guide unit further comprises a refractive layer formed on an outer surface of the guide part.

4. The illumination device of claim 3, wherein the guide part is made of a plastic or glass material, and the refractive layer is made of a material having a refractive index lower than that of the guide part.

5. The illumination device of claim 3, wherein the light guide unit further comprises a reflective layer formed on an outer surface of the refractive layer.

6. The illumination device of claim 5, wherein the reflective layer is made of a metallic material or a resin material containing a light reflective material.

7. The illumination device of claim 1, wherein the lens part has any one of a circular shape, an oval shape, and a polyhedral shape.

8. The illumination device of claim 1, wherein the lens part comprises protrusions formed on an outer surface thereof.

9. The illumination device of claim 2, wherein a space between the accommodation recess and the light emitting device is filled with an adhesive or a phosphor layer.

10. The illumination device of claim 1, wherein the substrate further comprises a depressed recess formed in an upper surface thereof in which the light guide unit is mounted, and light from the light emitting device mounted in the recess is reflected to the light guide unit.

11. The illumination device of claim 1, wherein the substrate further comprises a mounting recess in which the light guide unit is mounted.

12. The illumination device of claim 1, further comprising a fastening unit allowing the light guide unit to be detachably mounted on the substrate.

13. The illumination device of claim 12, wherein the fastening unit comprises a female screw thread provided in the substrate and a male screw thread provided on the light guide unit to engage with the female screw thread, and fastening is performed by fastening the female screw thread and the male screw thread.

14. The illumination device of claim 13, wherein the fastening unit comprises an adapter provided at one end of the light guide unit coupled with the substrate, and the male screw thread is formed on the adapter.

15. The illumination device of claim 13, wherein the fastening unit comprises an adapter provided at one end of the light guide unit coupled with the substrate and an auxiliary adapter provided on the substrate such that it corresponds to the adapter, and the female screw thread is formed on an inner face of the adapter and the male screw thread is formed on an outer face of the auxiliary adapter provided on the substrate.

16. The illumination device of claim 12, wherein the fastening unit comprises a plurality of coupling holes provided in the substrate and a plurality of elastic snap fits having stop protrusions and provided on the light guide unit, and fastening is performed by stop-fixing the snap fits and the coupling recesses.

17. The illumination device of claim 16, wherein the fastening unit comprises an adapter provided at one end of the light guide unit coupled with the substrate, and the snap fits are formed on the adapter.

18. The illumination device of claim 1, further comprising a cover unit covering the light source and the light guide unit to protect them.
